(19) United States
(12) Patent Application Publication
(10) Pub. No.: US 2005/0108150 A1
(43) Pub. Date: May 19, 2005

(54) Method and system for creating wind index values supporting the settlement of risk transfer and derivative contracts

(76) Inventors: David Glynn Pethick, London (GB); Christopher Patrick Clancy, Kent (GB)

Correspondence Address: PATENT DEPARTMENT;SKADDEN, ARPS, SLATE, MEAGHER & FLOM LLP, FOUR TIMES SQUARE, NEW YORK, NY, 10036, US

(21) Appl. No.: 10/174,138

(22) Filed: Jun. 18, 2002

(51) Int. Cl. G06F 17/60

(52) U.S. Cl. 705/38

(57) ABSTRACT

A system and method for creating index values supporting the settlement of wind risk transfer contracts is disclosed. The method includes calculating a first power value as a function of historical wind speeds and a power curve associated with the facility. A second power value is calculated based on the power curve and measured wind speed associated with the facility during a given period. The first and second power values are compared to yield an index. In one embodiment of the invention, an offset is added to the historical wind speed data to compensate for differences between the expected wind speeds at the facility and the region for which the historical data is available. In a further embodiment of the invention, a gain is multiplied by the sum of the offset and historical wind speed data to further compensate for differences between the local and regional wind speeds. In another aspect of the invention, a risk transfer vehicle is disclosed. The risk transfer vehicle includes a risk transfer contract having a strike price, a contract period, and a structure (such as a put option or swap). The payout for the risk transfer contract is determined based on the strike price, the structure and the wind power index for the contract period. The wind power index being a function of first and second power generation values, each of which are based on a power curve and historical and measured wind speeds, respectively.

### FIELD OF THE INVENTION

The present invention relates to a method and system for supporting wind risk-based financial contracts, including derivative instruments. More particularly, it relates to a method and system for creating wind power index values particularly suitable for supporting the settlement of wind risk transfer contracts, including wind derivatives.

### BACKGROUND OF THE INVENTION

Recent events have led to unprecedented levels of interest in investment in renewable energy generation assets. For example, the European Union recently published a directive setting an overall target of doubling the proportion of renewable energy by 2010. One well known renewable energy source that is predicted to form the basis for much renewable energy growth is wind power generation.

One significant hindrance to the development of wind power is the degree of risk involved. Advances in turbine technology have removed the much of the mechanical risks from development of wind power generation assets. In addition, recent legislative measures have removed much of the political risk (such as lack of regulatory support) from wind power generation. However, one very significant risk remains—that is, what if the wind does not blow, or blows too hard?

Wind risk is defined as the risk that the wind speed does not meet expectations. Wind risk is one of the greatest risks for companies in the wind power generation industry, as variability in wind speed has a significant impact on the volume of electricity generated and consequently on revenues. The annual variability of wind speed is recognized as the dominant factor in the year-to-year variability of wind farm production. In practice, this year-to-year variability can exceed 50%.

There is a significant need to manage wind risk in order to allow operators to stabilize wind power revenues and more closely maintain revenue in line with expectations such as during periods of lower-than-expected wind speeds. The ability to mitigate risk (from the perspective of an operator or developer) and manage revenues would reduce the cost-of-capital and spur the development of future wind power systems by enabling developers to finance projects on improved risk-adjusted terms. This, in turn, could materially contribute to the conservation of energy resources and the enhancement of the quality of the environment.

Until the present invention, there has been no efficient market mechanism for wind power operators to transfer and manage wind risk. Thus, the wind power generation industry has no efficient way of transferring wind risk away from operators and their financiers to third parties willing to assume such risk.

A traditional means for transferring risk among parties is a risk transfer contract, such as an insurance contract or an option or future whose value is derived from an underlying measure. The aim of risk transfer contracts is to transfer risk from those who have an excessive exposure to such risk and/or desire to hedge it, to those who wish to take on more of the risk either in anticipation of the possibility of profit or to offset their own negatively correlated risk.

Certain types of weather based risk transfer contracts have been used with varying degrees of success. In the case of weather-based risk transfer contracts, the “underlying” is typically an index based on a measurable weather factor such as temperature, rainfall, snow depth or sunshine hours, as recorded at one or more specified reference locations. An “index” is the numerical representation or estimation of the magnitude of some underlying phenomenon.

Most wind power operators wish to transfer low wind speed—and thus low power generation—risk. Theoretically, this transfer of risk could be achieved through the purchase of a put option or the sale of a swap. A put option is a contract where the buyer pays a premium to a seller for the potential to receive a payout if an actual index amount is less than a predetermined strike level. A swap is a combined call option and put option. Both options in the swap typically have the same predetermined strike level where the option pays out. For a swap, counterparties typically agree to a strike level over a period of time, with the firm providing the cover or paying out an agreed amount per index point when the index is below the agreed strike level, and the hedger paying out when the index is above that level.

However, to date, risk transfer contracts have not been used extensively for wind power operators. The primary problems with prior art wind power risk transfer contracts have been that they either had significant “basis risk” (i.e., poor correlation between the wind power operator's losses and the contract payout), or they required the insurer to assume risk which is more appropriately held by the operator (e.g., mechanical risk). Typically, prior art risk transfer contracts either used wind speed or measured power output as the “underlying.” If the underlying is based on measured wind speed, it does not mirror the expected power generated—thus, introducing significant basis risk for the wind farmer. On the other hand, if the underlying is based on measured power output, the investor would have to assume the operator's mechanical risk and would also be subject to the risk of manipulation of outputs by wind farm operators.

Accordingly, there is a need for a method and system for generating an index suitable for use in risk transfer contracts to allow wind power generators to mitigate wind risk and investors to invest in such risk. As noted above, other parties may also be interested in offsetting their own negatively correlated risks by accepting certain risk transfer contracts from wind power operators.

### SUMMARY OF THE INVENTION

The present invention provides a method and system of generating wind index values for a facility. The wind index values are useful for supporting the settlement of risk transfer contracts. The method includes calculating a first power value as a function of historical wind speeds and a power curve associated with the facility. A second power value is calculated based on the power curve and measured wind speed associated with the facility during a given period. The first and second power values are compared to yield an index.

In one aspect of the invention, the historical wind speed data is adjusted by a correlation factor to compensate for differences between the expected wind speeds at the facility and the region for which the historical data is available. In one embodiment, the correlation factor comprises an offset which is added to the historical wind speed data. In another embodiment, the correlation factor comprises an offset and a gain factor to further correlate the calculated historical wind speed to actual wind speeds at the facility.

In another aspect of the invention, a risk transfer vehicle is disclosed. In one embodiment, the risk transfer vehicle includes a risk transfer contract having a strike price, a contract period, and a structure (such as a put option, swap, a collar, or a digital option). The payout for the risk transfer contract is determined based on the strike price, the structure and the wind power index for the contract period. The wind power index being a function of first and second power generation values, each of which are based on a power curve, as well as historical and measured wind speeds, respectively.

### BRIEF DESCRIPTION OF THE DRAWINGS

These and other aspects of the present invention are more apparent in the following detailed description and claims, particularly when considered in conjunction with the accompanying drawings showing a system and method in accordance with the present invention, in which:

FIG. 1 is a schematic showing objects associated with facilities in a preferred embodiment of the invention;

FIG. 2 is a flow chart of a preferred method of generating expected power generation values;

FIG. 3 is a flow chart for linearly interpolating power curves;

FIG. 4 is a flow chart of a preferred method of determining index values for a given period;

FIG. 5 is an illustration of one embodiment of a system in accordance with one aspect of the present invention;

FIG. 6 is a schematic showing objects associated with risk transfer contracts in a preferred embodiment of the invention;

FIGS. 7A and 7B are illustrations of exemplary payouts for risk transfer contracts in accordance with the invention; and

FIGS. 8A and 8B are illustrations of typical histograms of unmatched and matched, respectively, local and regional wind speed data.

### DETAILED DESCRIPTION OF INVENTION

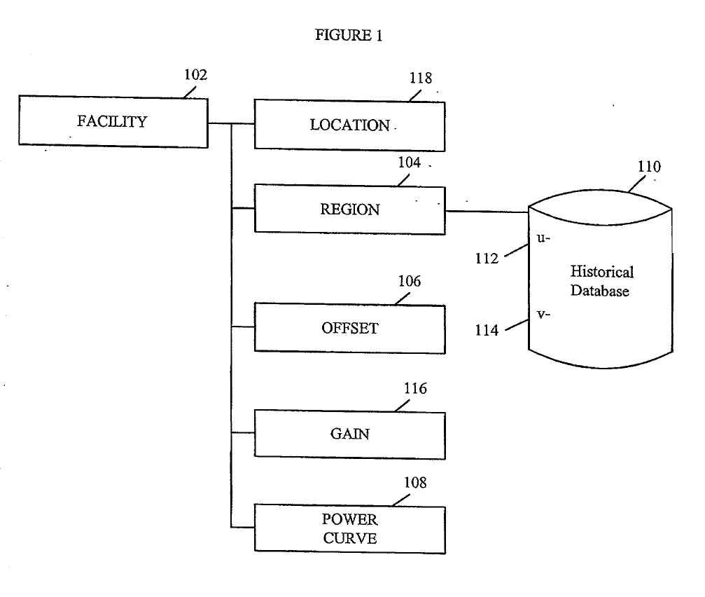

Preferred embodiments of the invention are discussed below with reference to FIGS. 1 to 8.

In a preferred embodiment, individual wind power indexes are associated with each “facility.” A facility is located at a particular site 116 and comprises a power generation system containing one or more homogeneous or heterogeneous power turbines. As shown in FIG. 1, each facility 102 is preferably associated with a region 104, an offset 106, a gain 116, and at least one turbine and/or associated power curve 108. Power curve 108 is preferably an individual power generation curve associated with the specific turbine located at the facility. In another alternative, the index may be calculated for a number of heterogeneous turbines located at a facility. In such case, power curve 108 preferably represents a weighted curve of the associated power curves of each of the heterogeneous turbines, or a series of power curves are used and the results of the instantaneous power calculations (described below) are summed.

A region 104 is simply a geographical area for which historical wind measurement data (shown as database 110) is available. The facility is preferably located within region 104. The primary source of regional wind speed data is NCEP Reanalysis data provided by the NOAA-CIRES Climate Diagnostics Center, Boulder, Colo., USA, from their Web site at http://www.cdc.noaa.gov. Other sources of wind speed measurement data include climatic or synoptic measurements of wind speed from surface stations, such as those operated and calibrated by the national meteorological agency for a given country. When using NCEP Reanalysis data, the variables used are preferably the sigma 995 level U and V component average wind speed. The U-component 112 and V-component 114 represent the longitudinal and latitudinal components of wind speed. This data is typically available from the NOAA-CDC FTP server located at: ftp://ftp.cdc.noaa.gov/Datasets/ncep.reanalysis.dailyavgs/surface. The files containing the daily data required are vwnd.sig995.xxxx.nc and uwnd.sig995.xxxx.nc, where xxxx is the year of the calculation period. If available, other data, such as hourly measurements, may be used.

The individual measurements of U-component 112 and V-component 114 average wind speed are combined using the following equation:

Windspeed1=(U²+V²)^{0.5}

In one embodiment of the invention, wind direction is accounted for through the use of vector addition. This may be desirable where the wind direction is variable and the wind turbine is sensitive to wind direction.

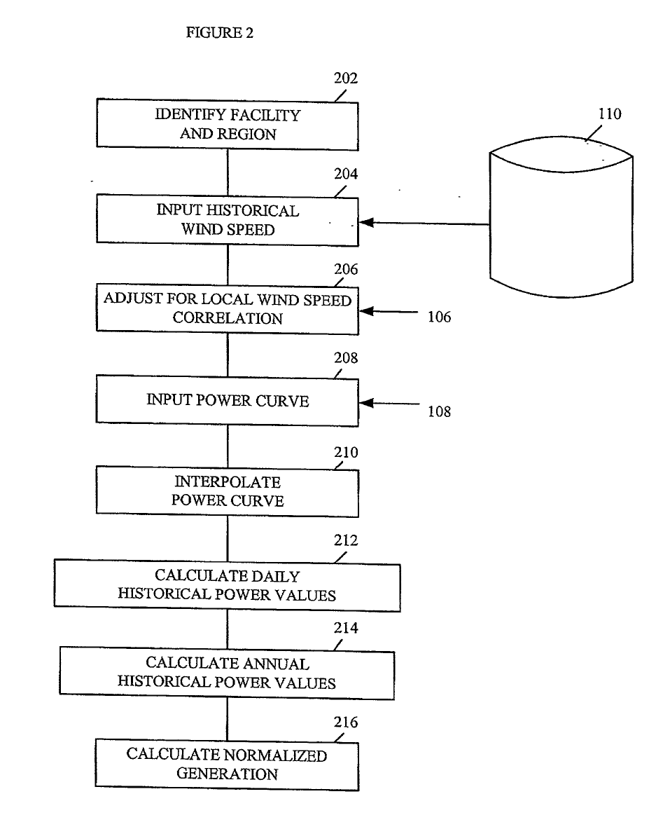

FIG. 2 shows a preferred method for calculating a wind power index in accordance with the present invention. First, the facility 102 and associated region 104 is identified (step 202). Second, historical wind speed 110 for the region 104 is input and Windspeed1 is calculated (step 204). Next, the system adjusts for the difference between local wind speed and regional wind speed using a correlation factor (step 206). The correlation factor preferably includes an offset 106 and a gain factor 116. In other embodiments, either offset 106 or gain 116 are used alone as the correlation factor. If both an offset 106 and gain 116 are available, Windspeed2 is preferably calculated as follows:
Windspeed2=(Windspeed1+Offset)*Gain
If only an offset 106 is available, offset 106 is added to the wind speed, as follows:
Windspeed2=Windspeed1+Offset
Alternatively, if only a gain 116 is available, gain 116 is multiplied by Windspeed1 as follows:
Windspeed2=Windspeed1*Gain

Offset 106 and gain 116 preferably remain fixed throughout the historical period being examined.

The correlation factor compensates for the difference between actual facility-site wind speeds and the region 104 wind speeds. Since wind power facilities are often positioned where local wind speeds are relatively high, the correlation factor will typically result in increased wind speed estimates. Offset 106 and gain 116 may be derived from energy yield studies which are commonly conducted when a wind power facility is proposed. Such energy yield studies typically estimate the “expected power generation.” Additionally, local wind speed distribution statistics and/or local raw wind speed data (collectively, referred to herein as “wind speed distribution data”) showing wind speeds across time at location 118 may be available from such energy yield studies or can be separately determined through known means.

If only “expected power generation” data is available (i.e., no wind speed distribution data is available), offset 106 and gain 116 may be calculated by matching the expected power generation with “normal” generation calculated from regional wind data. When matching “expected power generation” with regional calculated power generation alone, an optimization loop is preferably run in which the correlation factor is increased or decreased until the calculated “normal” generation is within a threshold percentage, preferably 0.25%, of the expected power generation. In a preferred embodiment, either offset 106 or gain 116 are increased for each iteration. Offset 106 is preferably adjusted as follows:
Delta offset=absolute(((normal generation-expected generation)/expected generation)^{1/3})
Gain 116 is preferably adjusted as follows:
Gain=Gain+/−X %, where X is preferably about 1.
The optimization loop continues until the “normal” generation is within the threshold percentage of the expected power generation. “Normal” generation is calculated utilizing power curve 108 and the regional historical wind speed data 112 and 114 in the manner described below with respect to steps 208-214.

If wind speed distribution data is available or simulated as described below, offset 106 and gain 116 are preferably calculated by matching the wind speed distribution data with measured regional wind speeds. In a preferred embodiment of the invention, offset 106 and gain 116 are calculated by matching the wind speed distribution data with measured regional wind speeds using a distribution matching algorithm, as is know in the art. If wind speed distribution statistics are available (but actual raw wind speed data is not), raw wind speed measurements are preferably simulated from the distribution statistics. Wind speed distribution statistics are typically modeled using the well known Weibull distribution function. If the Weibull statistical data is available, raw wind speed measurements are preferably simulated using the “weibrnd” function available on the Matlab™ statistics toolbox available from The Mathworks, Inc, Natick, Mass.

Once the raw wind speed measurements are available—whether actual or simulated—the regional and local data are matched, preferably using a distribution matching algorithm. Regional wind speed measurements 112, 114 (Windspeed1) are extracted from database 110 for a given period. Histograms for the site wind speed measurements, whether real or simulated, and the regional wind speed measurements 112, 114 are calculated. The preferred bin width for the histograms is about 1 meter per second (m/s) in the preferred range of at least 0-15 m/s. A standard optimization of the following equation is run until the distribution differences are minimized:
Corrected=(Windspeed1+offset)*gain
where,
   the range of the offset variable 106 is preferably limited
      within −5 m/s and +5 m/s; and
   the range of the gain factor 116 is preferably limited
      within 0.1 and 3.0.

The distribution differences are preferably calculated as follows:
Difference=Σabs(N1ᵢ−N2ᵢ) for i=1 to n
where,
   n is the number of bins,
   N1ᵢ=number of site wind speed occurrences in the i^{th} bin, and
   N2ᵢ=number of regional wind speed occurrences in the i^{th} bin.

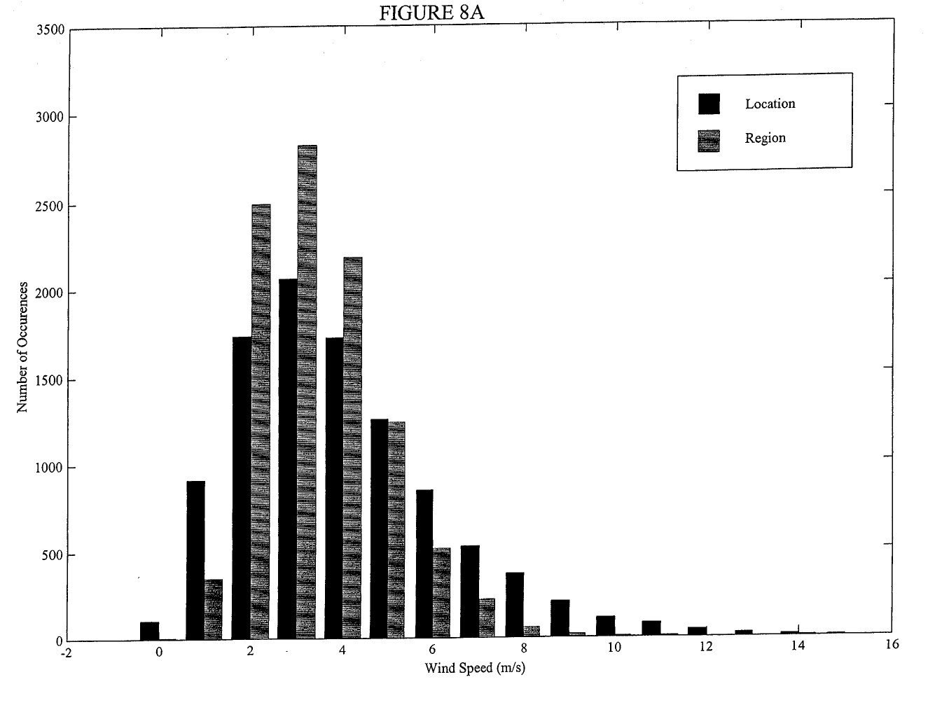

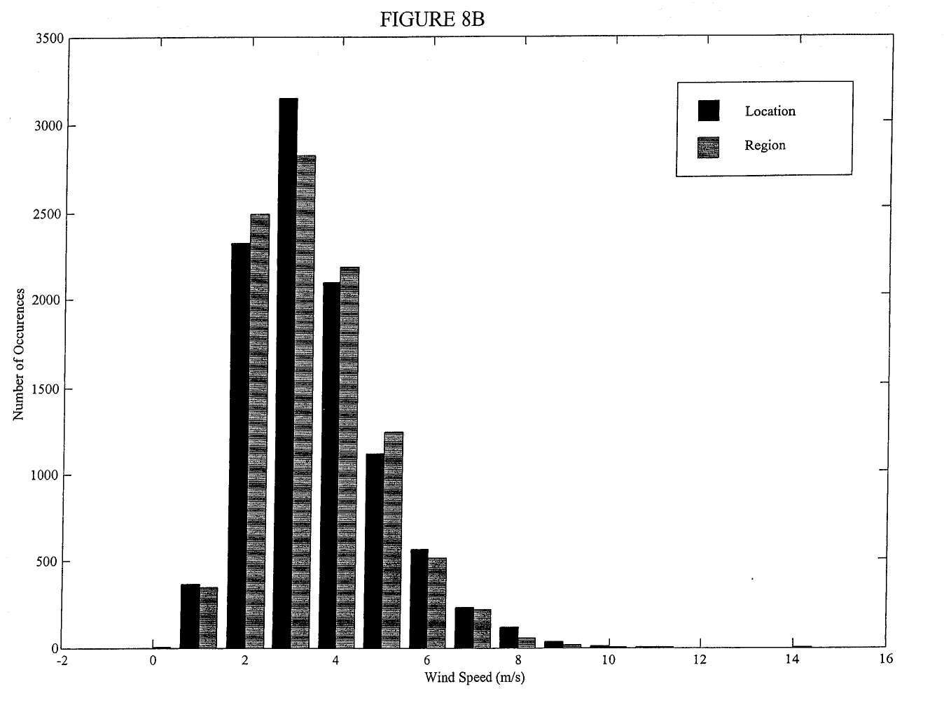

FIGS. 8A and 8B show of typical histograms of unmatched and matched, respectively, local and regional wind speed data. As shown in FIG. 8A, local measurements typically have a stronger central tendency than the regional measurements.

With continued reference to FIG. 2, a power curve 108 associated with the facility 102 is input to the system (step 208). Power curves are available from a number of public sources, such as www.windpower.dk. For example, Table 1 shows the Power Curve for the NEG Micon 900/52.

TABLE 1

| Wind Speed | Instantaneous Power | Power/Day |
|---|---|---|
| (Average Daily) | Generated (kW) | (kWh/day) |
| <4 | 0 | 0 |
| 4 | 27 | 648 |
| 5 | 67 | 1,608 |
| 6 | 117 | 2,808 |
| 7 | 199 | 4,776 |
| 8 | 303 | 7,272 |
| 9 | 420 | 10,080 |
| 10 | 541 | 12,984 |
| 11 | 644 | 15,456 |
| 12 | 732 | 17,568 |
| 13 | 801 | 19,224 |
| 14 | 849 | 20,376 |
| 15 | 880 | 21,120 |
| 16 | 894 | 21,456 |
| 17 | 900 | 21,600 |
| 18 | 897 | 21,528 |
| 19 | 892 | 21,408 |
| 20 | 887 | 21,288 |
| 21 | 883 | 21,192 |
| 22 | 880 | 21,120 |
| 23 | 879 | 21,096 |
| 24 | 881 | 21,144 |
| 25 | 884 | 21,216 |
| >25 | 0 | 0 |

It is significant to note that the NEG Micron 900/52, like most turbine systems, does not have a linear relationship between wind speed and power output. Also, like many turbine systems, the NEG Micron 900/52 can not be operated above certain wind speeds. Power curves for other turbines, such as, for example, those manufactured by Bonus, Nordex, Vestas, as well as other NEG turbines, are commonly available.

The power curve may have to be interpolated to provide an adequate level of accuracy. For example, power curves are typically only defined in integer units (i.e., power generation at 1,2,3,4 . . . m/s). A linear interpolation method is preferably used (step 210) to modify the power curves so that the power curves are defined to the appropriate level of accuracy, preferably tenths of meters per second (i.e., power generation at 1,1.1,1.2,1.3 . . . m/s). The instantaneous power generated is preferably calculated by reference to a power curve table and the average daily wind speed (i.e., Windspeed2 which includes offset 106), rounded to one decimal place. The daily average wind speed is preferably rounded to one decimal place where if the second number after the decimal point is five (5) or greater then the first number after the decimal point shall be increased by one (1), and if the second number after the decimal point is less than five (5) then the first number after the decimal point shall remain unchanged. If the rounded daily average wind speed is not an integer, then a linear interpolation between the integer values above and below the rounded daily average wind speed is used.

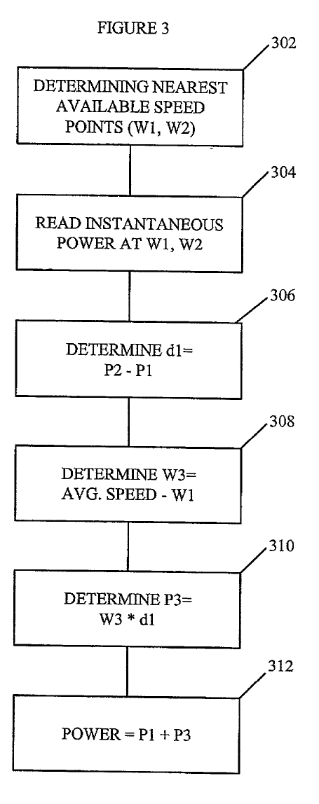

As shown in FIG. 3, the instantaneous power generated is preferably calculated using the linear interpolation as follows: First, the wind speed integer levels surrounding the rounded daily average wind speed, Windspeed2 are determined (step 302). This is done by rounding down the daily average wind speed (Windspeed2) to the nearest integers (W1, W2). Next, the instantaneous power generated at wind speed levels W1 and W2 is read off the table (step 304). These are referred to herein as P1 and P2. Next, the difference (d1) between the instantaneous power generated for wind speed levels W1 and W2 (i.e., P2-P1) is determined (step 306). Next, the difference between the rounded daily average wind speed (Windspeed2) and W1 is determined (step 308). This is referred to as W3. W3 will have a value between 0.1 and 0.9 if daily average wind speeds with a single decimal are used. Next, a linear interpolation factor (P3) is determined by multiplying W3 by d1 (step 310). Finally, P3 to P1 are added to determine the instantaneous power for the non-integer rounder daily average wind speed (step 312). Other methods of interpolation may be used.

While Table 1 shows an instantaneous power generated of zero for wind speeds greater than 25 m/s, the power curve may be artificially manipulated to show some non-zero constant for wind speeds above a certain threshold. This may be appropriate, for example, in the case of a hedger who only wishes to assume low wind risk and not the risk of excessive wind speeds. This will often be the case for hedgers seeking to offset their own high wind risk.

With continued reference to FIG. 2, the daily historical power value is calculated (step 212) for each day in the historical period as the instantaneous power calculated for the daily average wind speed, multiplied by 24. As shown in Table 1, the units of the daily historical power is preferably kilowatt-hours per day (“kWh/day”) or an equivalent unit of measure. (Note: although these are labeled daily historical power values, they represent values which would have been expected to have occurred given the historical wind speeds and turbine technology.) In one embodiment, there need not have been any actual wind power captured at such sites during the historical period. The annual expected generation in each year is calculated (step 214) as the sum of the power generated per day for each day in the calender year. Time periods other than daily and yearly may be used. The average annual expected generation over a given period is calculated by averaging the annual expected generation for the period (step 216) and defined as the “normal” generation for this particular location and turbine technology. In a preferred embodiment, this period is the last 10 full years. The “normal” generation is fixed to be the same value as the expected average generation because the offset 106 has been added to the daily average wind speed historical figures.

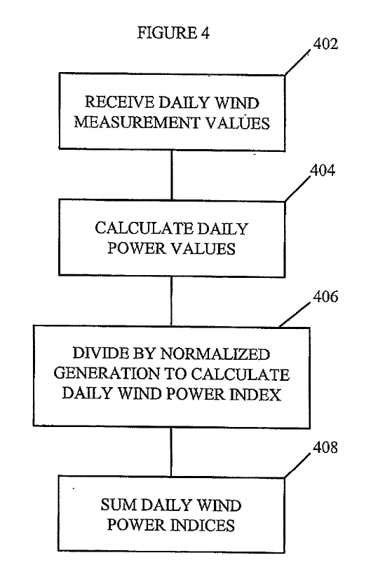

Once the “normal” generation for given location and turbine technology is calculated for a given period, daily measurements are then compared to the normal values to create an index value. With reference to FIG. 4, daily wind speed measurements are preferably received from region 104. Measurements may, alternately, be received at other intervals or continuously. The daily power value is then calculated (step 404) in the manner described above (including any correlation using offset 106 and gain 116 and interpolation) with respect to steps 206-212. If wind direction is accounted for in calculating Windspeed1 (above), then it must also be accounted for in step 404 using a vector calculation. In an alternate embodiment, daily speed measurements are received from the location 118 or a spot sufficiently adjacent to, or having wind speeds correlated to, the location 118. In this alternate embodiment, there is no need to correlate the local data to the region data using offset 106 or gain 116, however, the hedger in such an embodiment assumes the risk that the correlation factor (i.e., offset 106 and gain 116) are too low. The daily power value is then divided by the total “normal” generation for the given period, and multiplied by 100 (step 406). This defines the daily wind power index value. The wind power index for a given period (e.g., a season or year) is calculated (step 408) as the sum of the daily wind power index values.

In a perfectly “normal” year, the wind power index will be equal to 100. In a year when the wind power index is 95, this indicates the Wind Power Index is 95% of normal values (i.e., 5% below normal). The use of normalized wind power calculations (i.e., normalized to 100) further facilitates the trading of risk transfer contracts.

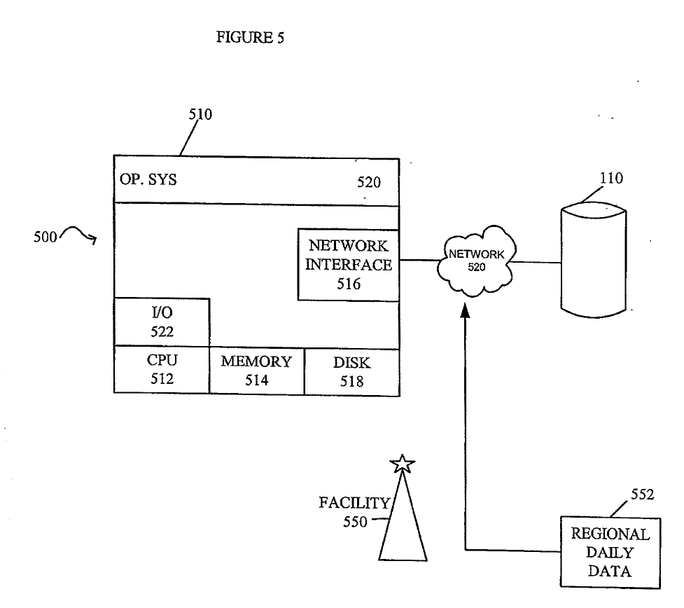

Referring now to FIG. 5, there is shown an illustration of a system 500 operating in accordance with an embodiment of the present invention. The system 500 includes a computer 510, such as a server, coupled to a database 110 via a network 520, such as the Internet. Computer 510 may be of conventional design, and includes a processor 512, randomly addressable memory (RAM) 514, network interface 516, local or networked hard disk memory 518, input/output interface 522, and a display (not shown). The computer 510 preferably executes a conventional operating system 520. Preferably database 110 is cached into a local database (not shown) and/or memory 514 or disk 518.

Regional wind measurements 552 are received, preferably on a daily basis via a network (such as 520). Alternatively, wind measurement may be taken local to the facility 550, such as by an appropriate measurement device (not shown) mounted on, or near, the wind power tower.

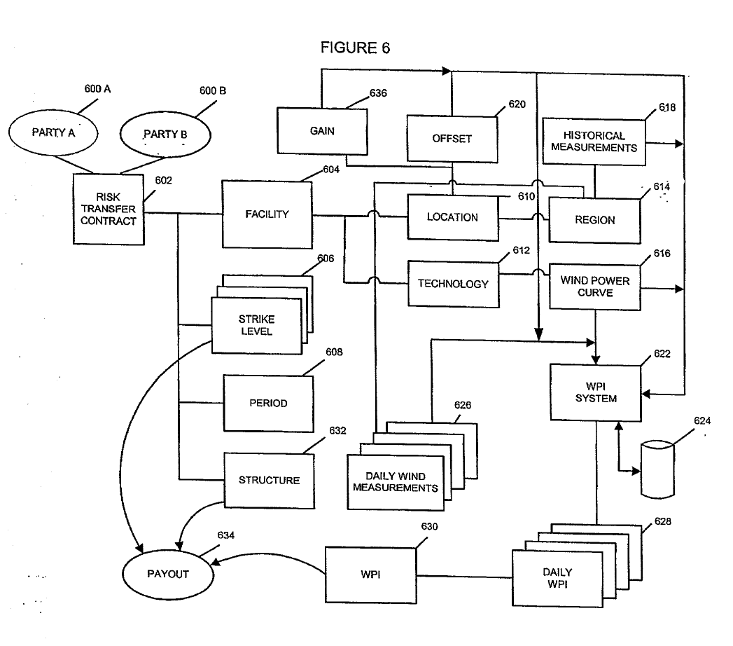

With reference to FIG. 6, an exemplary risk transfer vehicle in accordance with one aspect of the present invention will be described. A risk transfer contract 602 is entered into between two or more parties 600A and 600B. Risk transfer contract 602 has a given structure 632, such as a put option, a swap, a collar or a digital option. Other risk transfer vehicles include insurance contracts (not shown). Risk transfer contract 602 is associated with a facility 604, one or more strike levels 606 and a contract period 608. As noted above, facility 604 is associated with a location 610 and, preferably, a wind power technology 612 such as a specific wind turbine. Wind power technology 612 is associated with a wind power curve 616, and location 610 is associated with region 614, offset 620 and gain 636. Historical wind measurements 618 for the region 614, together with an offset 620 and a gain 636 associated with the location 610, are combined with power curve 616 by the wind power index system 622 to calculate “normal” wind power generation 624 for periods corresponding to contract period 608.

Daily wind measurements 626 are received for each day in the contract period 608, preferably from region 626. The daily measurements 626 are combined with power curve 616, offset 620 and gain 636, and are compared with the normal wind power generation 624 by the wind power index system 622 to calculate a series of daily wind power values 628. One daily wind power value 628 preferably is generated for each day in the contract period 608. The daily wind power values are combined to yield a wind power index 630 for contract period 608. The wind power index 630 is compared to the strike level(s) 606 and, depending on the contract structure 632, a payout 634 between party A 600A and party B 600B may be required.

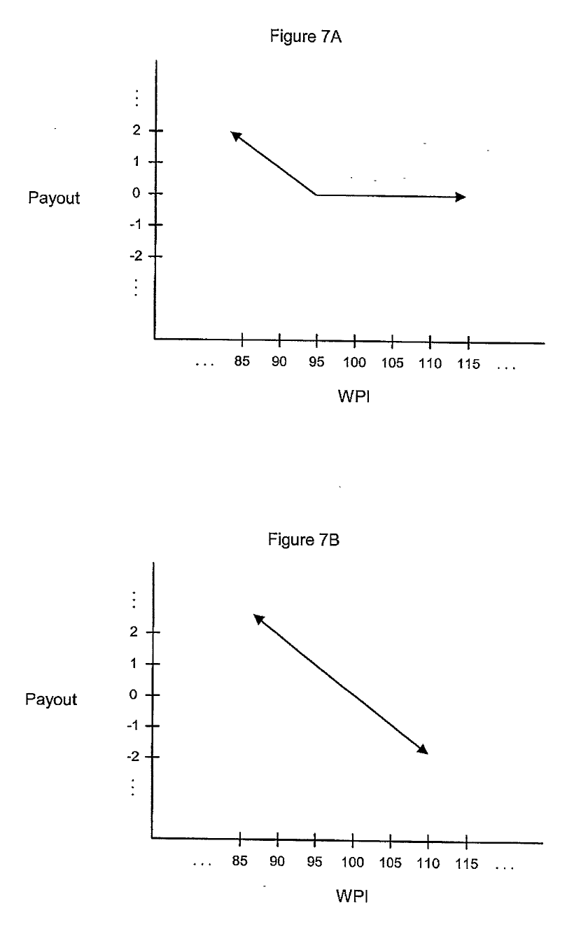

FIGS. 7A and 7B illustrate exemplary payouts for risk transfer contracts in accordance with the invention. FIG. 7A illustrates an exemplary payout for a put option having a strike level of 95. As shown in FIG. 7A, there is no payout as long as the WPI is above 95. That is as long as it is the WPI for the contract period at a given location and forgiven technology is at or above ninety-five percent of the normal or expected value, there is no payout between the parties. If the WPI drops below ninety-five percent of normal, the buyer (i.e., the wind power operator) will receive a payout from the seller. The size of the payout depends on the WPI and the contract assignment. In this way a wind power operator can protect against low, but not unlikely, wind generation due to variability in wind speeds.

FIG. 7B illustrates an exemplary payout for a swap having a strike level of 100. As shown in FIG. 7B, when the WPI is greater than 100 (i.e., the calculated wind power generated is better than normal) the hedger (i.e., the wind power generator) will pay the coverer (i.e., the investor); and when the WPI is less than 100, the coverer will pay the hedger. In this way, a wind power operator can, for example, give up some upside potential in return for reduced downside risk. This may be a significant factor in enabling the operator to reduce its cost of capital. Alternatively, a collar structure may be used in which the put and call have different strike levels (not shown).

Many other contract structures may be used within the scope of the invention. One embodiment of the invention utilizes a digital option contract structure. Digital options provide a buyer with a fixed payout profile in which the buyer receives the same payout irrespective of how far “in the money” the option closes. A digital option, therefore, can guarantee an operator a floor amount of power generation/payout.

Although the specification and illustrations of the invention contain many particulars, these should not be construed as limiting the scope of the invention but as merely providing an illustration of the preferred embodiments of the invention. Thus, the claims should be construed as encompassing all features of patentable novelty that reside in the present invention, including all features that would be treated as equivalents by those skilled in the art.

1. A method, with the aid of a computer system, of creating a wind power index (“WPI”) for a facility, the WPI being useful for supporting risk transfer contracts, the method comprising:
a) receiving historical wind data associated with the facility;
b) receiving a correlation factor associated with said facility;
c) inputting a power curve associated with the facility, the power curve defining power output as a function of wind speed;
d) calculating a first power value for said facility over a first period as a function of said historical wind data, said correlation factor and said power curve;
e) receiving a series of wind measurements over a second period;
f) calculating a second power value for said facility over said second period as a function of said wind measurements, and said power curve; and
g) comparing said first power value and said second power value to yield said WPI.

2. The method of claim 1 further comprising interpolating said power curve, said calculation of said first power value and said calculation of said second power value using said interpolated power curve.

3. The method of claim 1 wherein said correlation factor comprises an offset; said historical wind data is defined for a series of units of time; said power curve data comprises a table correlating expected power output and wind speed; said first power value calculation comprising:
adding said offset to said historical wind data to produce a summed wind speed for each unit of time in said series;
looking-up a first power output in said table corresponding to said summed wind speed for each said unit of time in said series; and
summing said looked-up first power outputs to produce a normal power output for said period.

4. The method of claim 3 wherein said looking-up of said table further comprises interpolating said table.

5. The method of claim 3 wherein said second power value calculation comprises looking-up a second power output in said table for each said wind measurement in said series of wind measurements.

6. The method of claim 5 wherein said comparing said first power value and said second power value comprises:
dividing each said looked-up second power output by said normal power output to produce a series of per time unit WPI; and
summing each said per time unit WPI's to yield said WPI.

7. The method of claim 5 wherein said comparing said first power value and said second power value comprises:
summing each said looked-up power output to produce a summed power output for said period; and
dividing said summed power output by said normal power output to yield said WPI.

8. The method of claim 1 wherein step (g) of comparing said first power value and said second power value comprises normalizing said WPI.

9. The method of claim 1 wherein the WPI is used to settle a risk transfer contract, the method further comprising:
comparing said WPI to a contract strike level associated with a risk transfer contract; and
determining a payout for said risk transfer contract based on said comparison.

10. The method of claim 1 further comprising:
creating a risk transfer contract, said risk transfer contract being associated with a contract structure and at least one contract strike level;
comparing said at least one contract strike level to said WPI; and
determining a payout for said risk transfer contract based on said comparison and said contract structure.

11. The method of claim 10 wherein said contract structure is a put option.

12. The method of claim 10 wherein said contract structure is a swap.

13. The method of claim 1 further comprising receiving a gain associated with said facility, said calculation of said first power value further being a function of said gain.

14. The method of claim 13 wherein said gain is calculated using a distribution matching algorithm.

15. The method of claim 1 wherein said facility is associated with a region, said historical wind data and said series wind measurement being associated with said region, said calculation of said second power value further comprises correlating said series of wind measurements to said facility.

16. The method of claim 15 wherein said calculation of said second power value is a function of said correlation factor.

17. The method of claim 15 wherein said correlation factor comprises a gain and an offset associated with said facility; said calculation of said second power function being a function of said offset and said gain.

18. The method of claim 1 wherein said historical wind data is defined for a series of units of time and said power curve data comprises a table correlating expected power output and wind speed, said correlation factor comprising a gain and an offset associated with said facility; said first power value calculation comprising:
adding said offset to said historical wind data to produce a summed wind speed for each unit of time in said series;
multiplying said gain by said summed wind speed to produce a adjusted wind speed for each unit of time in said series;
looking-up a first power output in said table corresponding to said adjusted wind speed for each said unit of time in said series; and
summing said looked-up first power outputs to produce a normal power output for said period.

19. A system for creating a wind power index (“WPI”) for a facility, the WPI being useful for supporting risk transfer contracts, the system comprising at least one computer collectively programmed to:
a) receive historical wind data associated with the facility;
b) receive a correlation factor associated with said facility;
c) receive a power curve associated with the facility, the power curve defining power output as a function of wind speed;
d) calculate a first power value for said facility over a first period as a function of said historical wind data, said correlation factor and said power curve;
e) receive a series of wind measurements over a second period;
f) calculate a second power value for said facility over said second period as a function of said wind measurements and said power curve; and
g) compare said first power value and said second power value to yield said WPI.

20. A system for creating a wind power index (“WPI”) for a facility, the WPI being useful for supporting risk transfer contracts, the system comprising:
a) a means for receiving historical wind data associated with the facility;
b) a means for receiving a correlation factor associated with said facility;
c) a means for receiving a power curve associated with the facility, the power curve defining power output as a function of wind speed;
d) a means for calculating a first power value for said facility over a first period as a function of said historical wind data, said correlation factor and said power curve;
e) a means for receiving a series of wind measurements associated with said facility over a said second period;
f) a means for calculating a second power value for said facility over said second period as a function of said wind measurements and said power curve; and
g) a means for comparing said first power value and said second power value to yield said WPI.

21. A computer-readable medium storing a plurality of instructions to be executed by at least one processor for creating a wind power index (“WPI”) for a facility, the WPI being useful for supporting risk transfer contracts, said plurality of instructions comprising instructions to:
a) receive historical wind data associated with the facility;
b) receive a correlation factor associated with said facility;
c) receive a power curve associated with the facility, the power curve defining power output as a function of wind speed;
d) calculate a first power value for said facility over a first period as a function of said historical wind data, said correlation factor and said power curve;
e) receive a series of wind measurements over a second period;
f) calculate a second power value for said facility over said second period as a function of said wind measurements and said power curve; and
g) compare said first power value and said second power value to yield said WPI.

22. A method, with the aid of a digital computer, of transferring risk among parties comprising:
a) identifying a facility, the facility being associated with a power curve and a location;
b) identifying a risk transfer contract, said risk transfer contract having a contract period and at least one strike level;
c) identifying historical wind measurements associated with said location;
d) calculating, using a computer, a first power generation based on said historical wind measurements and said power curve for at least one period corresponding to said contract period;
e) receiving, during said contract period, wind measurements;
f) calculating, using a computer, a second power generation based on said received wind measurement and said power curve;
f) calculating a wind power index by comparing said second power generation with said first power generation; and
g) determining a payout for said risk transfer contract based on a comparison of said wind power index to said at least one strike level.

23. The method of claim 22 wherein said location is associated with a region, said historical wind measurements being associated with said region.

24. The method of claim 23 wherein said location is further associated with a correlation factor, said calculation of said first power generation being based on said power curve, said historical wind measurements, and said correlation factor.

25. A method, with the aid of a digital computer, of transferring risk among parties comprising:
a) receiving a power curve and a location, said power curve and said location associated with a facility;
b) receiving risk transfer contract information, said risk transfer contract information including a contract period and at least one strike level;
c) receiving historical wind measurements associated with said location;
d) calculating a first power generation based on said historical wind measurements and said power curve for periods corresponding to said contract period;
e) receiving, during said contract period, wind measurements;
f) calculating a second power generation based on said received wind measurement and said power curve;
g) calculating a wind power index by comparing said second power generation with said first power generation; and
h) determining a payout for said risk transfer contract based on a comparison of said wind power index to said at least one strike level.

26. The method of claim 25 wherein said risk transfer contract is a put option.

27. The method of claim 25 wherein said risk transfer contract is a swap.

28. The method of claim 25 wherein said risk transfer contract is a collar.

29. The method of claim 25 wherein said risk transfer contract is a digital option.

30. The method of claim 25 wherein said location is associated with a region, said historical wind measurements being associated with said region.

31. The method of claim 30 wherein said facility is further associated with a correlation factor, said calculation of said first power generation being based on said power curve, said historical wind measurements, and said correlation factor.

32. The method of claim 25 wherein said calculation of said second power generation further comprises calculating daily wind power values.

33. The method of claim 32 wherein said contract period covers a time span including a plurality of days, said calculation of said a wind power index comprising summing said daily wind power values for each day in said contract period.

34. The method of claim 31 wherein said correlation factor comprises a gain and an offset; said calculation of said first power generation being based on said power curve and said historical wind measurements plus said offset times said gain; said calculation of said second power generation being based on said power curve and said series of wind measurements plus said offset times said gain.

35. A system for transferring risk among parties, the system comprising at least one computer collectively programmed to:
a) receive a power curve and a location, said power curve and said location associated with a facility;
b) receive risk transfer contract information, said risk transfer contract information including a contract period and at least one strike level;
c) receive historical wind measurements associated with said location;
d) calculate a first power generation based on said historical wind measurements and said power curve for periods corresponding to said contract period;
e) receive, during said contract period, wind measurements;
f) calculate a second power generation based on said received wind measurement and said power curve;
g) calculate a wind power index by comparing said second power generation with said first power generation; and
h) determine a payout for said risk transfer contract based on a comparison of said wind power index to said at least one strike level.

36. The system of claim 35 wherein said location is associated with an offset and a region and said historical wind measurements being associated with said region; said calculation of said first power generation being based on said power curve and said historical wind measurements plus said offset.

37. A system for transferring risk among parties comprising:
a) means for receiving a power curve and a location, said power curve and said location associated with a facility;
b) means for receiving risk transfer contract information, said risk transfer contract information including a contract period and at least one strike level;
c) means for receiving historical wind measurements associated with said location;
d) means for calculating a first power generation based on said historical wind measurements and said power curve for periods corresponding to said contract period;
e) means for receiving, during said contract period, wind measurements;
f) means for calculating a second power generation based on said received wind measurement and said power curve;
g) means for calculating a wind power index by comparing said second power generation with said first power generation; and
h) means for determining a payout for said risk transfer contract based on a comparison of said wind power index to said at least one strike level.

38. The system of claim 37 wherein said location is associated with a region and said historical wind measurements being associated with said region; said means for calculating said first power generation being based on said power curve and said historical wind measurements plus said offset.

39. A risk transfer vehicle comprising:
a risk transfer contract having a strike price, a contract period and a structure, the risk transfer contract associated with a location and a power curve, the location associated with historical wind measurements for periods corresponding to said contract period;
a wind power index (“WPI”), the WPI being a function of a first power generation data and a second power generation data, said first power generation data being a function of said historical wind measurements and said power curve, said second power generation data being a function wind measurements associated with said location during said contract period and said power curve; and
a payout associated with said risk transfer contract, the payout being based on said strike price, said structure and said WPI.

40. The risk transfer vehicle of claim 39 wherein the structure is a put option.

41. The risk transfer vehicle of claim 39 wherein the structure is a swap.

42. The risk transfer vehicle of claim 39 wherein said structure is a collar.

43. The risk transfer vehicle of claim 39 wherein said structure is a digital option.

44. The risk transfer vehicle of claim 39 wherein said risk transfer contract is further associated with an offset, said first power generation data being a function of said offset added to said historical wind measurements and said power curve.

45. A risk transfer vehicle comprising:
a risk transfer contract having a strike price, a contract period and a structure, the risk transfer contract associated with a location and a power curve, the location associated with historical wind measurements for periods corresponding to said contract period;
first power generation data, said first power generation data being associated with said historical wind measurements and said power curve;
wind measurements associated with said location and said contract period;
second power generation data, said second power generation data being associated with said wind measurements and said power curve;
a wind power index (“WPI”), the WPI being a function of said first power generation data and said second power generation data; and
a payout associated with said risk transfer contract, the payout being based on said strike price, said structure and said WPI.

46. The risk transfer vehicle of claim 45 wherein the structure is a put option.

47. The risk transfer vehicle of claim 45 wherein the structure is a swap.

48. The risk transfer vehicle of claim 45 wherein said structure is a collar.

49. The risk transfer vehicle of claim 45 wherein said structure is a digital option.

50. The risk transfer vehicle of claim 45 wherein said risk transfer contract is further associated with an offset, said first power generation data being a function of said offset added to said historical wind measurements and said power curve.

51. The method of claim 50 wherein said location is associated with a region, said wind measurements associate with said location being associated with said region.
